(19) United States
(12) Patent Application Publication
(10) Pub. No.: US 2012/0306736 A1
(43) Pub. Date: Dec. 6, 2012

(54) SYSTEM AND METHOD TO CONTROL SURVEILLANCE CAMERAS VIA A FOOTPRINT

(75) Inventors: Hari Thiruvengada, Plymouth, MN (US); Paul Derby, Lubbock, TX (US); Tom Plocher, Hugo, MN (US); Henry Chen, Beijing (CN)

(73) Assignee: Honeywell International Inc., Morristown, NJ (US)

(21) Appl. No.: 13/152,817

(22) Filed: Jun. 3, 2011

(51) Int. Cl. G09G 5/00

(52) U.S. Cl. 345/156

(57) ABSTRACT

A system includes a video sensing device, a computer processor coupled to the video sensing device, and a display unit coupled to the computer processor. The system is configured to display on the display unit a footprint of the video sensing device in an environment, receive input from a user that directly alters the footprint of the video sensing device, calculate a change in one or more of a pan, a tilt, and a zoom of the video sensing device as a function of the direct alteration of the footprint, alter one or more of the pan, the tilt, and the zoom of the video sensing device as a function of the calculations, and display a field of view of the video sensing device on the display unit as a function of the altered pan, tilt, and zoom of the video sensing device.

### TECHNICAL FIELD

The present disclosure relates to a system and method to control surveillance cameras, and in an embodiment, but not by way of limitation, controlling surveillance cameras by altering a footprint on a video display unit.

### BACKGROUND

Controlling video cameras is problematic for security/surveillance personnel. Current camera control interfaces require operators to change camera pan, tilt, or zoom by changing the value of each separately, often by literally changing the numeric value for the selected camera parameter. These values translate poorly, if at all, to what the operator actually sees on the system's video display unit. What security operators care most about are things moving on the ground (intruders), and the location of intruders on the ground.

### BRIEF DESCRIPTION OF THE DRAWINGS

FIG. 1A illustrates a footprint of a video sensing device and a widget for changing the location of the footprint.

FIG. 1B illustrates a footprint of a video sensing device and widget for changing the size of the footprint.

FIG. 2 illustrates a camera icon and a footprint icon.

FIGS. 3A and 3B are a flowchart of an example process for changing a pan, tilt, and zoom of a video sensing device via manipulation of a footprint on a video display unit.

FIG. 4 is a block diagram of a computer processor system upon which one or more embodiments of the invention can execute.

### DETAILED DESCRIPTION

In light of the issues with the control of camera surveillance systems as discussed above, what would be useful to security personnel is a metaphor that allows an operator to easily place a footprint of a camera (i.e., the area of ground covered by a camera's field of view) over the location of interest. Such a metaphor would allow the operator to control the camera's pan, tilt, and zoom parameters in an easy and seamless manner without complicated mental transformations.

In an embodiment, there are several distinctive methods and metaphors that can be used for controlling the pan, tilt, and zoom parameters of the camera. The idea is to allow the operator to either directly drag the footprint of the camera over the location that they want to see, or to use a set of handles on the footprint graphic to change the shape or position of the footprint. Other ways include changing the camera image using pan, tilt, and zoom control handles or direct manipulation on the camera image. An algorithm, which is described more fully below, takes these user actions on the footprint graphic and translates them into pan, tilt, and zoom commands for the camera. The actual pan, tilt, and zoom changes are transparent to the user. The user only sees the result of the control actions in the video and in a camera coverage fan (icon) displayed on an outdoor map, indoor floor plan, or other images and layouts. Every camera has limits however, and when the operator attempts to exceed these limits, the operator will receive a message about it.

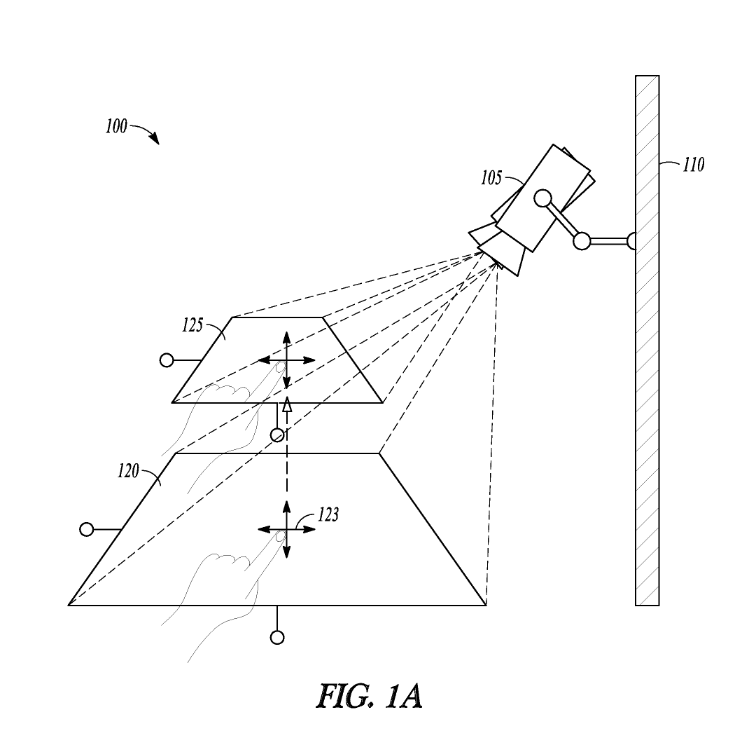

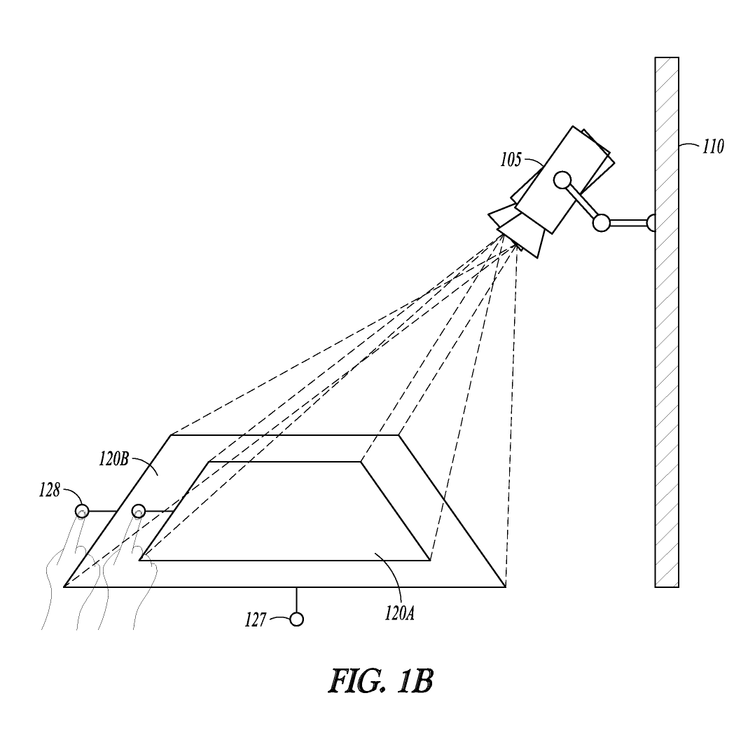

FIG. 1A illustrates a footprint of a video sensing device and a widget for changing the location of the footprint. In the scenario 100 of FIG. 1A, a video sensing device 105 is mounted to a wall 110. The area of coverage on the ground caused by the field of view of the camera can be referred to as the footprint 120. The location of the footprint 120 can be changed by clicking on cursor (or widget) 123, and moving the cursor and footprint to a new location within the field of view, for example, to location/footprint 125. The system determines the new location 125 on the display unit as it relates to the image on the display unit, and calculates new values for the pan, tilt, and zoom of the camera 105 that will result in the camera having the footprint 125. Similarly, as illustrated in FIG. 1B, widgets 127 and/or 128 can be used to alter the shape of the footprint 120, changing the footprint 120A into a larger footprint 120B.

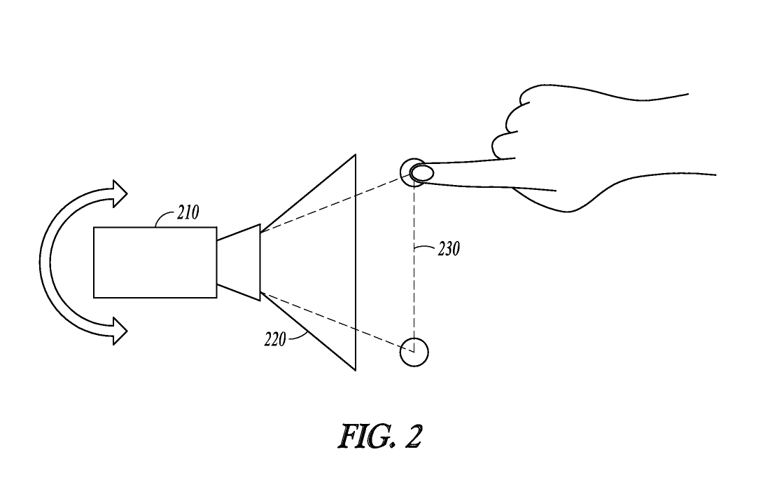

In an embodiment, as illustrated in FIG. 2, the system displays a camera icon 210 and a footprint icon 220, and a user can modify such a footprint icon 220. The system senses the changes to the footprint 220, and calculates the changes needed for the pan, tilt, and zoom of the camera to provide the new footprint to the user. If a user chooses a footprint 230 that is beyond the capabilities of camera 210, as illustrated in FIG. 2 wherein the chosen footprint 230 is outside the footprint capabilities 220 of the camera 210, the system informs the user of this situation. In an embodiment, the system will display on the display unit the field of view that the camera is capable of displaying.

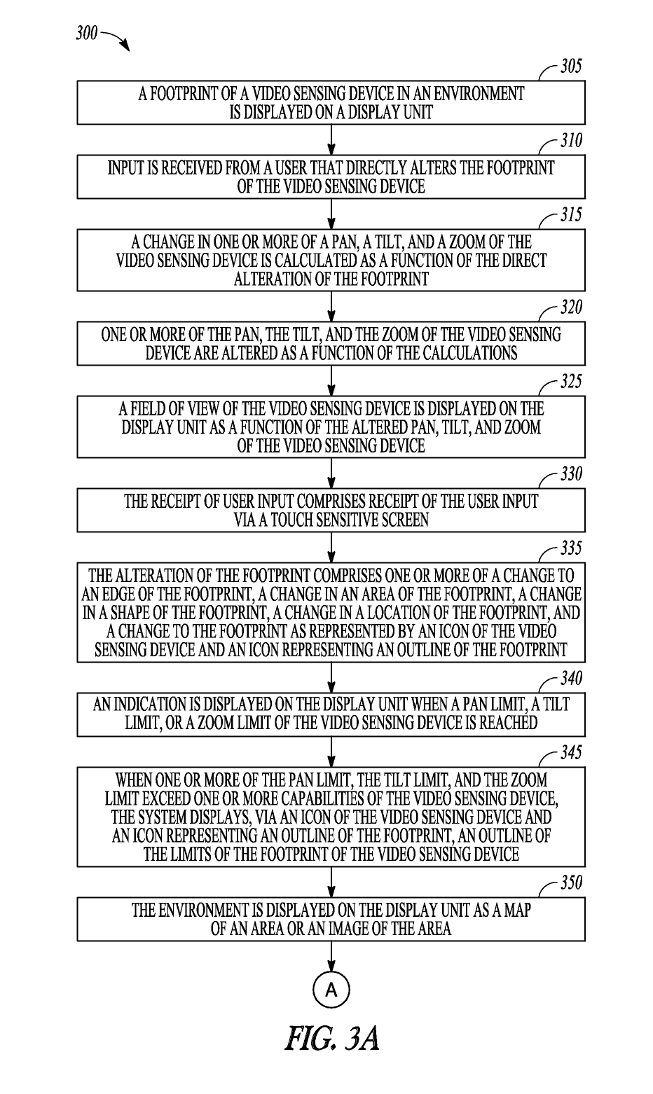

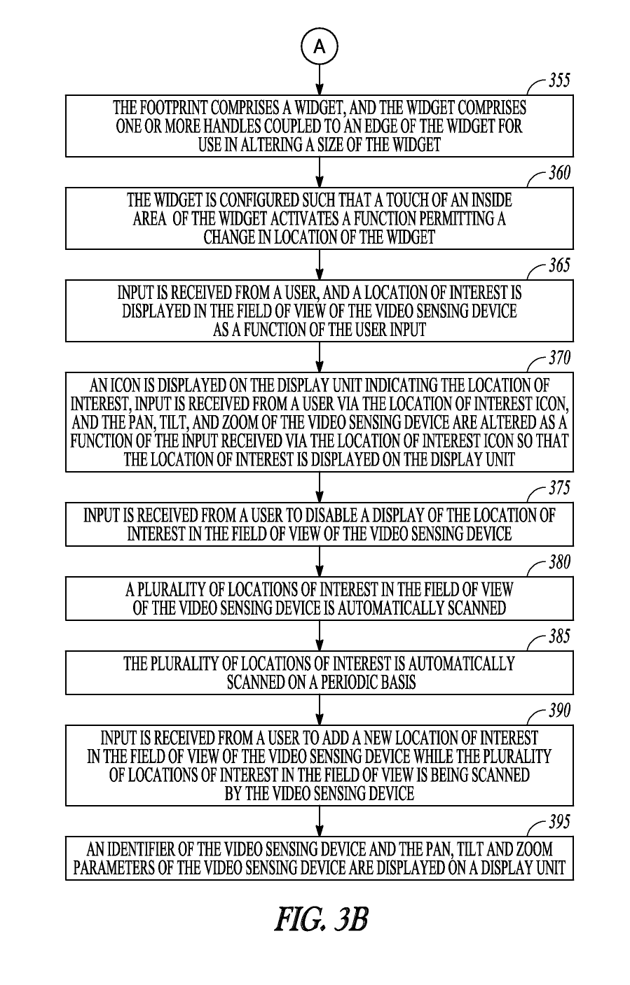

FIGS. 3A and 3B are a flowchart of an example process 300 for changing a pan, tilt, and zoom of a video sensing device via manipulation of a footprint on a video display unit. FIGS. 3A and 3B include a number of process blocks 305-395. Though arranged serially in the example of FIGS. 3A and 3B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIGS. 3A and 3B, at 305, a footprint of a video sensing device in an environment is displayed on a display unit. At 310, input is received from a user that directly alters the footprint of the video sensing device. At 315, a change in one or more of a pan, a tilt, and a zoom of the video sensing device is calculated as a function of the direct alteration of the footprint. At 320, one or more of the pan, the tilt, and the zoom of the video sensing device are altered as a function of the calculations. At 325, a field of view of the video sensing device is displayed on the display unit as a function of the altered pan, tilt, and zoom of the video sensing device.

At 330, the receipt of user input comprises receipt of the user input via a touch sensitive screen. At 335, the alteration of the footprint comprises one or more of a change to an edge of the footprint, a change in an area of the footprint, a change in a shape of the footprint, a change in a location of the footprint, and a change to the footprint as represented by an icon of the video sensing device and an icon representing an outline of the footprint.

At 340, an indication is displayed on the display unit when a pan limit, a tilt limit, or a zoom limit of the video sensing device is reached. At 345, when one or more of the pan limit, the tilt limit, and the zoom limit exceed one or more capabilities of the video sensing device, the system displays, via an icon of the video sensing device and an icon representing an outline of the footprint, an outline of the limits of the footprint of the video sensing device. At 350, the environment is displayed on the display unit as a map of an area or an image of the area. At 355, the footprint comprises a widget, and the widget comprises one or more handles coupled to an edge of the widget for use in altering a size of the widget. At 360, the widget is configured such that a touch of an inside area of the widget activates a function permitting a change in location of the widget.

At 365, input is received from a user, and a location of interest is displayed in the field of view of the video sensing device as a function of the user input. A location of interest can also be referred to as a hotspot. At 370, an icon is displayed on the display unit indicating the location of interest, input is received from a user via the location of interest icon, and the pan, tilt, and zoom of the video sensing device are altered as a function of the input received via the location of interest icon so that the location of interest is displayed on the display unit. At 375, input is received from a user to disable a display of the location of interest in the field of view of the video sensing device. At 380, a plurality of locations of interest in the field of view of the video sensing device is automatically scanned. At 385, the plurality of locations of interest is automatically scanned on a periodic basis. At 390, input is received from a user to add a new location of interest in the field of view of the video sensing device while the plurality of locations of interest in the field of view is being scanned by the video sensing device. At 395, an identifier of the video sensing device and the pan, tilt and zoom parameters of the video sensing device are displayed on a display unit.

The algorithm that takes user actions on a footprint graphic and translates them into pan, tilt, and zoom commands for the camera is as follows. A current video feed is captured, several algorithms (e.g., edge detection, object detection, and video analytics) are applied to segment and translate the current scene to a frame and extract objects of interest in the scene. A foot print is overlaid on top of the current view, and when the user selects the foot print and modifies it, the current foot print (which is superimposed as an augmented widget on the real video image) is translated as an area with the real image of the current scene. This is also translated and mapped to camera PTZ parameters using geometric and trigonometric models. In this manner, there is a relationship between the actual foot print and camera PTZ parameters. When the foot print is moved or altered, the current PTZ parameters are altered and the algorithms (i.e., edge detection, object detection, and video analytics) are reapplied again on a continuous basis. In an embodiment, buffering and panoramic image stitching can be used to create a smooth transition of the live video image feed.

### Example Embodiments

In Example No. 1, a system includes a video sensing device, a computer processor coupled to the video sensing device, and a display unit coupled to the computer processor. The system is configured to display on the display unit a footprint of the video sensing device in an environment, receive input from a user that directly alters the footprint of the video sensing device, calculate a change in one or more of a pan, a tilt, and a zoom of the video sensing device as a function of the direct alteration of the footprint, alter one or more of the pan, the tilt, and the zoom of the video sensing device as a function of the calculations, and display a field of view of the video sensing device on the display unit as a function of the altered pan, tilt, and zoom of the video sensing device.

Example No. 2 includes the features of Example No. 1, and optionally includes a system wherein the receipt of user input includes receipt of the user input via a touch sensitive screen, and wherein the alteration of the footprint includes one or more of a change to an edge of the footprint, a change in an area of the footprint, a change in a shape of the footprint, a change in a location of the footprint, and a change to the footprint as represented by an icon of the video sensing device and an icon representing an outline of the footprint.

Example No. 3 includes the features of Example Nos. 1-2, and optionally includes a system configured to display an indication on the display unit when a pan limit, a tilt limit, or a zoom limit of the video sensing device is reached.

Example No. 4 includes the features of Example Nos. 1-3, and optionally includes a system wherein when one or more of the pan limit, the tilt limit, and the zoom limit exceed one or more capabilities of the video sensing device, the system displays, via an icon of the video sensing device and an icon representing an outline of the footprint, an outline of the limits of the footprint of the video sensing device.

Example No. 5 includes the features of Example Nos. 1-4, and optionally includes a system wherein the environment is displayed on the display unit as a map of an area or an image of the area.

Example No. 6 includes the features of Example Nos. 1-5, and optionally includes a system wherein the footprint includes a widget, and the widget includes one or more handles coupled to an edge of the widget for use in altering a size of the widget; and wherein the widget is configured such that a touch of an inside area of the widget activates a function permitting a change in location of the widget.

Example No. 7 includes the features of Example Nos. 1-6, and optionally includes a system configured to receive input from a user, and to display a location of interest in the field of view of the video sensing device as a function of the user input.

Example No. 8 includes the features of Example Nos. 1-7, and optionally includes a system configured to display an icon on the display unit indicating the location of interest, to receive input from the user via the location of interest icon, and to alter the pan, tilt, and zoom of the video sensing device as a function of the input received via the location of interest icon so that the location of interest is displayed on the display unit.

Example No. 9 includes the features of Example Nos. 1-8, and optionally includes a system configured to receive input from the user to disable a display of the location of interest in the field of view of the video sensing device.

Example No. 10 includes the features of Example Nos. 1-9, and optionally includes a system configured to automatically scan among a plurality of locations of interest in the field of view of the video sensing device.

Example No. 11 includes the features of Example Nos. 1-10, and optionally includes a system configured to automatically scan the plurality of locations of interest on a periodic basis.

Example No. 12 includes the features of Example Nos. 1-11, and optionally includes a system configured to receive input from a user to add a new location of interest in the field of view of the video sensing device while the plurality of locations of interest in the field of view is being scanned by the video sensing device.

Example No. 13 includes the features of Example Nos. 1-12, and optionally includes a system configured to display an identifier of the video sensing device and the pan, tilt and zoom parameters of the video sensing device.

Example No. 14 is a computer-readable medium including instructions that when executed by a processor executes a process including displaying on a display unit a footprint of a video sensing device in an environment, receiving input from a user that directly alters the footprint of the video sensing device, calculating a change in one or more of a pan, a tilt, and a zoom of the video sensing device as a function of the direct alteration of the footprint, altering one or more of the pan, the tilt, and the zoom of the video sensing device as a function of the calculations, and displaying a field of view of the video sensing device on the display unit as a function of the altered pan, tilt, and zoom of the video sensing device.

Example No. 15 includes the features of Example No. 14, and optionally includes instructions for receiving the user input via a touch sensitive screen, changing an edge of the footprint, changing an area of the footprint, changing a shape of the footprint, changing a location of the footprint, and changing the footprint as represented by an icon of the video sensing device and an icon representing an outline of the footprint.

Example No. 16 includes the features of Example Nos. 14-15, and optionally includes instructions wherein the footprint includes a widget, and the widget includes one or more handles coupled to an edge of the widget for use in altering a size of the widget; and wherein the widget is configured such that a touch of an inside area of the widget activates a function permitting a change in location of the widget.

Example No. 17 includes the features of Example Nos. 14-16, and optionally includes instructions for receiving input from a user, and displaying a location of interest in the field of view of the video sensing device as a function of the user input.

Example No. 18 is a process including displaying on a display unit a footprint of a video sensing device in an environment, receiving input from a user that directly alters the footprint of the video sensing device, calculating a change in one or more of a pan, a tilt, and a zoom of the video sensing device as a function of the direct alteration of the footprint, altering one or more of the pan, the tilt, and the zoom of the video sensing device as a function of the calculations, and displaying a field of view of the video sensing device on the display unit as a function of the altered pan, tilt, and zoom of the video sensing device.

Example No. 19 includes the features of Example No. 18 and optionally includes receiving the user input via a touch sensitive screen, changing an edge of the footprint, changing an area of the footprint, changing a shape of the footprint, changing a location of the footprint, and changing the footprint as represented by an icon of the video sensing device and an icon representing an outline of the footprint, wherein the footprint includes a widget, and the widget includes one or more handles coupled to an edge of the widget for use in altering a size of the widget, and wherein the widget is configured such that a touch of an inside area of the widget activates a function permitting a change in location of the widget.

Example No. 20 includes the features of Example Nos. 18-19, and optionally includes receiving input from a user, and displaying a location of interest in the field of view of the video sensing device as a function of the user input.

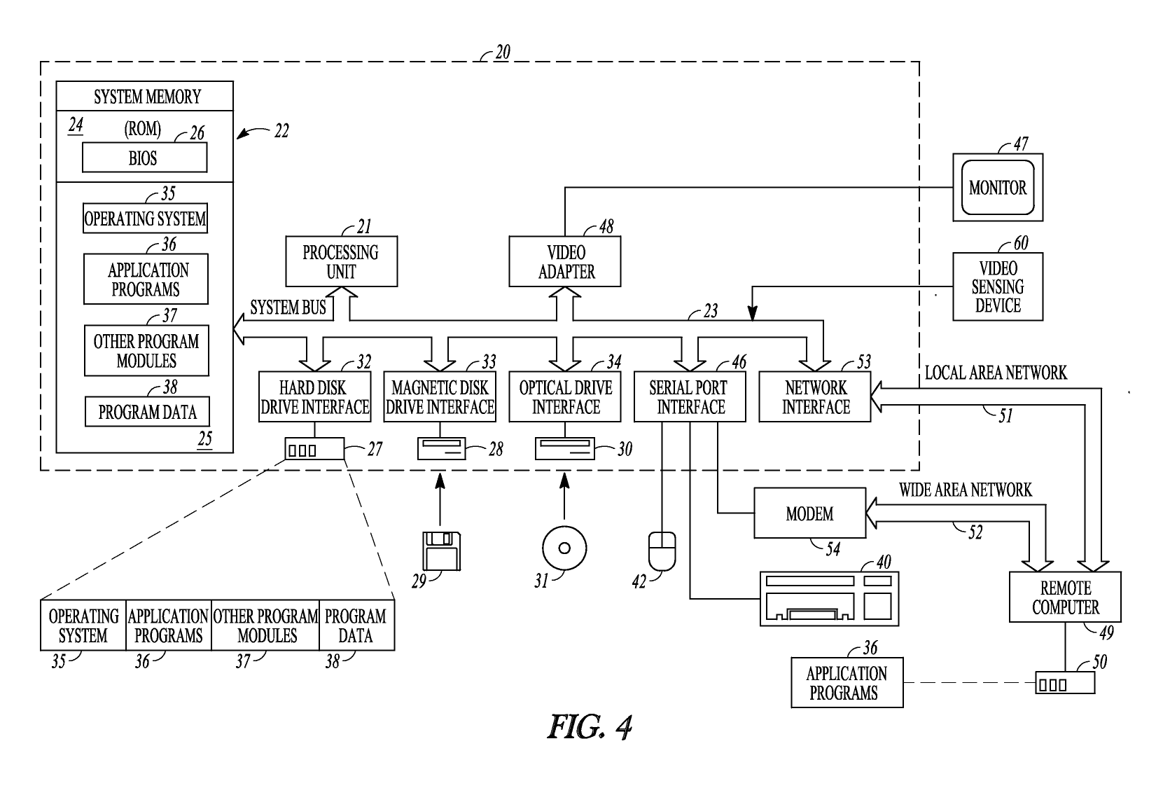

FIG. 4 is an overview diagram of a hardware and operating environment in conjunction with which embodiments of the invention may be practiced. The description of FIG. 4 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 4, a hardware and operating environment is provided that is applicable to any of the servers and/or remote clients shown in the other Figures.

As shown in FIG. 4, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/0 relative to the computer 20, although only a memory storage device 50 has been illustrated. The logical connections depicted in FIG. 4 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art. A video sensing device 60 can be coupled to the processing unit 21 via the system bus 23 and to the video monitor 47 via the system bus 23 and the video adapter 48.

It should be understood that there exist implementations of other variations and modifications of the invention and its various aspects, as may be readily apparent, for example, to those of ordinary skill in the art, and that the invention is not limited by specific embodiments described herein. Features and embodiments described above may be combined with each other in different combinations. It is therefore contemplated to cover any and all modifications, variations, combinations or equivalents that fall within the scope of the present invention.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
a video sensing device;
a computer processor coupled to the video sensing device; and
a display unit coupled to the computer processor;
wherein the system is configured to:
display on the display unit a footprint of the video sensing device in an environment;
receive input from a user that directly alters the footprint of the video sensing device;
calculate a change in one or more of a pan, a tilt, and a zoom of the video sensing device as a function of the direct alteration of the footprint;
alter one or more of the pan, the tilt, and the zoom of the video sensing device as a function of the calculations; and
display a field of view of the video sensing device on the display unit as a function of the altered pan, tilt, and zoom of the video sensing device.

2. The system of claim 1, wherein the receipt of user input comprises receipt of the user input via a touch sensitive screen, and wherein the alteration of the footprint comprises one or more of a change to an edge of the footprint, a change in an area of the footprint, a change in a shape of the footprint, a change in a location of the footprint, and a change to the footprint as represented by an icon of the video sensing device and an icon representing an outline of the footprint.

3. The system of claim 1, configured to display an indication on the display unit when a pan limit, a tilt limit, or a zoom limit of the video sensing device is reached.

4. The system of claim 3, wherein when one or more of the pan limit, the tilt limit, and the zoom limit exceed one or more capabilities of the video sensing device, the system displays, via an icon of the video sensing device and an icon representing an outline of the footprint, an outline of the limits of the footprint of the video sensing device.

5. The system of claim 1, wherein the environment is displayed on the display unit as a map of an area or an image of the area.

6. The system of claim 1, wherein the footprint comprises a widget, and the widget comprises one or more handles coupled to an edge of the widget for use in altering a size of the widget; and wherein the widget is configured such that a touch of an inside area of the widget activates a function permitting a change in location of the widget.

7. The system of claim 1, configured to receive input from a user, and to display a location of interest in the field of view of the video sensing device as a function of the user input.

8. The system of claim 7, configured to display an icon on the display unit indicating the location of interest, to receive input from the user via the location of interest icon, and to alter the pan, tilt, and zoom of the video sensing device as a function of the input received via the location of interest icon so that the location of interest is displayed on the display unit.

9. The system of claim 7, configured to receive input from the user to disable a display of the location of interest in the field of view of the video sensing device.

10. The system of claim 7, configured to automatically scan among a plurality of locations of interest in the field of view of the video sensing device.

11. The system of claim 10, configured to automatically scan the plurality of locations of interest on a periodic basis.

12. The system of claim 10, configured to receive input from a user to add a new location of interest in the field of view of the video sensing device while the plurality of locations of interest in the field of view is being scanned by the video sensing device.

13. The system of claim 1, configured to display an identifier of the video sensing device and the pan, tilt and zoom parameters of the video sensing device.

14. A computer-readable medium comprising instructions that when executed by a processor executes a process comprising:
displaying on a display unit a footprint of a video sensing device in an environment;
receiving input from a user that directly alters the footprint of the video sensing device;
calculating a change in one or more of a pan, a tilt, and a zoom of the video sensing device as a function of the direct alteration of the footprint;
altering one or more of the pan, the tilt, and the zoom of the video sensing device as a function of the calculations; and
displaying a field of view of the video sensing device on the display unit as a function of the altered pan, tilt, and zoom of the video sensing device.

15. The computer-readable medium of claim 14, comprising instructions for:
receiving the user input via a touch sensitive screen;
changing an edge of the footprint;
changing an area of the footprint;
changing a shape of the footprint;
changing a location of the footprint; and
changing the footprint as represented by an icon of the video sensing device and an icon representing an outline of the footprint.

16. The computer-readable medium of claim 14, wherein the footprint comprises a widget, and the widget comprises one or more handles coupled to an edge of the widget for use in altering a size of the widget; and wherein the widget is configured such that a touch of an inside area of the widget activates a function permitting a change in location of the widget.

17. The computer-readable medium of claim 14, comprising instructions for receiving input from a user, and displaying a location of interest in the field of view of the video sensing device as a function of the user input.

18. A process comprising:
displaying on a display unit a footprint of a video sensing device in an environment;
receiving input from a user that directly alters the footprint of the video sensing device;
calculating a change in one or more of a pan, a tilt, and a zoom of the video sensing device as a function of the direct alteration of the footprint;
altering one or more of the pan, the tilt, and the zoom of the video sensing device as a function of the calculations; and
displaying a field of view of the video sensing device on the display unit as a function of the altered pan, tilt, and zoom of the video sensing device.

19. The process of claim 18, comprising:
receiving the user input via a touch sensitive screen;
changing an edge of the footprint;
changing an area of the footprint;
changing a shape of the footprint;
changing a location of the footprint; and
changing the footprint as represented by an icon of the video sensing device and an icon representing an outline of the footprint;
wherein the footprint comprises a widget, and the widget comprises one or more handles coupled to an edge of the widget for use in altering a size of the widget; and wherein the widget is configured such that a touch of an inside area of the widget activates a function permitting a change in location of the widget.

20. The process of claim 18, comprising receiving input from a user, and displaying a location of interest in the field of view of the video sensing device as a function of the user input.
